(19) United States
(12) Patent Application Publication
(10) Pub. No.: US 2011/0283093 A1
(43) Pub. Date: Nov. 17, 2011

(54) MINIMIZING PROGRAM EXECUTION TIME FOR PARALLEL PROCESSING

(75) Inventors: Kei Imada, Hamura-shi (JP); Ryuji Sakai, Hanno-shi (JP)

(73) Assignee: KABUSHIKI KAISHA TOSHIBA, Tokyo (JP)

(21) Appl. No.: 13/193,583

(22) Filed: Jul. 28, 2011

Related U.S. Application Data
(63) Continuation of application No. 12/491,119, filed on Jun. 24, 2009.

(30) Foreign Application Priority Data
Jun. 30, 2008 (JP) 2008-170975

(51) Int. Cl. G06F 9/318

(52) U.S. Cl. 712/226; 712/E09.035

(57) ABSTRACT

According to one embodiment, an information processing apparatus comprises a storage storing program modules and parallel execution control description describing relationships of the program modules, a conversion module extracting a part relating to the program module from the parallel execution control description, and creating graph data structure creation information including preceding and succeeding information of the program module, an adding module extracting graph data structure creation information to which the input data is given, creating a node, and adding the created node to a formerly created graph data structure, and an execution module subjecting the graph data structure to at least one of first search and second search with a restricted breadth, selecting one node from nodes stored in the node memory, and executing a program module corresponding to the selected node.

### CROSS-REFERENCE TO RELATED APPLICATIONS

This application is a continuation of application Ser. No. 12/491,119, filed Jun. 24, 2009, which is based upon and claims the benefit of priority from Japanese Patent Application No. 2008-170975, filed Jun. 30, 2008, each of which is hereby incorporated by reference in its entirety.

### BACKGROUND

1. Field

One embodiment of the invention relates to an information processing apparatus, a program execution method, and a storage medium storing computer program for parallel processing.

2. Description of the Related Art

In order to increase the processing speed of a computer, multithreading is used to execute a plurality of processes in parallel. In a program for parallel execution based on conventional multithreading, a plurality of threads are created, and programming taking into account that each thread will undergo synchronous execution must be adopted. For example, to appropriately maintain execution order, it is necessary to insert code for guaranteeing synchronism at various points in a program, which makes debugging of the program difficult, and increases the maintenance cost.

As an example of such a program for parallel execution, there is a multithread execution method described in Jpn. Pat. Appln. KOKAI Publication No. 2005-258920. Here, there is disclosed a method for realizing, when a plurality of threads (thread 1 can be executed only after completion of thread 2) having interdependence are created, a method for realizing parallel execution on the basis of the execution results of the threads and the interdependence between the threads.

In this method, it is necessary to hard-code the interdependence between the threads in the program, and hence there have been problems that the program lacks flexibility in allowing changes to be made, that description of managing synchronization between the threads is difficult, and that it is difficult to obtain scalability in the number of processors.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing an example of a system configuration view according to this embodiment.

FIG. 2 is an exemplary view showing an example of flow of a conventional program for parallel execution.

FIG. 3 is an exemplary view for explaining an example of a program division method according this embodiment.

FIG. 4 is an exemplary view for explaining an example of interdependence between nodes according to this embodiment.

FIG. 5 is an exemplary view showing an example of translation of a program according to this embodiment.

FIGS. 6A and 6B are exemplary views for explaining an example of a node according to this embodiment.

FIG. 7 is an exemplary view showing an example of graph data structure creation information of a node according to this embodiment.

FIG. 8 is an exemplary flowchart showing an example of execution flow for adding a graph data structure according to this embodiment.

FIG. 9 is an exemplary flowchart showing an example of basic module execution according to this embodiment.

FIG. 10 is an exemplary view showing an example of a hierarchical structure of a cache memory according to this embodiment.

FIG. 11 is an exemplary view showing a tree structure of an example of a node arrangement state at the time of parallel execution.

FIGS. 12A and 12B are exemplary views showing an example of executing first search for determining a node to be executed next.

FIGS. 13A and 13B are exemplary views showing an example of executing second search for determining a node to be executed next.

FIGS. 14A and 14B are exemplary views showing an example of executing second search in which a return upper limit is set.

FIG. 15 is exemplary flowchart showing an example of execution for determining an appropriate value of the return upper limit.

FIGS. 16A and 16B are exemplary views showing an example of a state where first search is preferable.

FIGS. 17A and 17B are exemplary views showing an example of executing first search for determining a node.

### DETAILED DESCRIPTION

Various embodiments according to the invention will be described hereinafter with reference to the accompanying drawings. In general, according to one embodiment of the invention, an information processing apparatus comprises a storage storing program modules and parallel execution control description describing relationships of the program modules; a conversion module extracting a part relating to the program module from the parallel execution control description, and creating graph data structure creation information including preceding and succeeding information of the program module; an adding module extracting graph data structure creation information to which the input data is given, creating a node, and adding the created node to a formerly created graph data structure; and an execution module subjecting the graph data structure to at least one of first search and second search with a restricted breadth, selecting one node from nodes stored in the node memory, and executing a program module corresponding to the selected node.

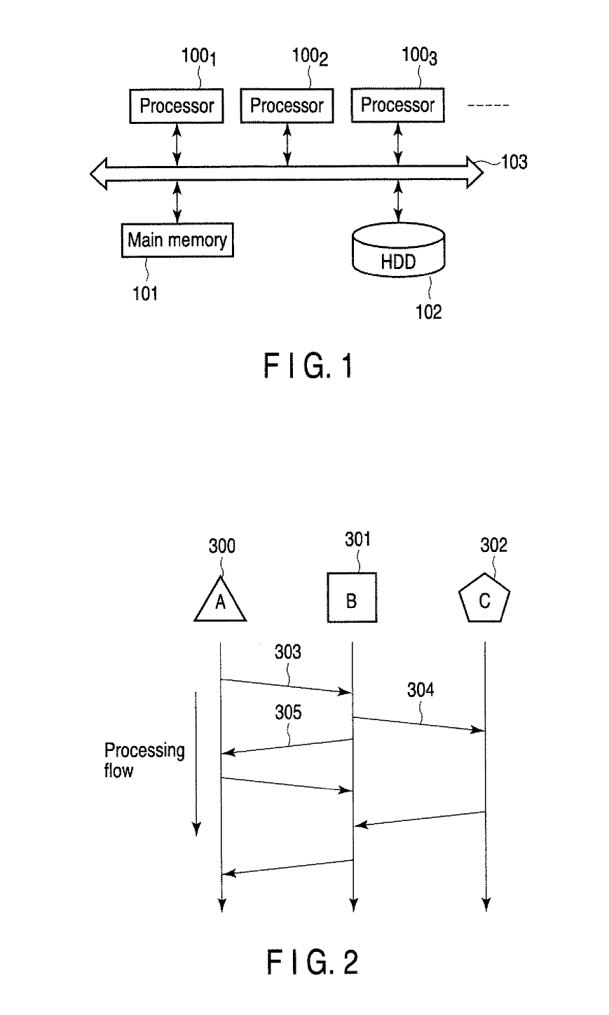

FIG. 1 is a view showing an example of a configuration of an information processing apparatus according to a first embodiment of the present invention.

Processors 100ᵢ (i=1, 2, . . . ) for realizing parallel processing, a main memory 101, and a hard disk drive (HDD) 102 are connected to an internal bus 103. Each of the processors 100ᵢ has functions of interpreting program code stored in various storage devices such as the main memory 101, HDD 102, and the like, and executing processing described in advance as a program. It is assumed that three processors 100ᵢ each of which is capable of equal throughput are provided. However, the processors are not necessarily identical processors, and those different from each other in throughput, and those for processing different types of code may be included.

The main memory 101 includes a storage device formed of a semiconductor memory such as a DRAM and the like. Programs to be executed by the processors 100ᵢ are read into the main memory 101 accessible at a relatively high speed prior to the processing, and are accessed from the processors 100ᵢ in accordance with the program execution.

Although the HDD 102 can store a larger amount of data than the main memory 101, the HDD 102 is disadvantageous in the access speed in many cases. Program code to be executed by the processors 100ᵢ is stored in advance in the HDD 102, and only parts to be executed are read into the main memory 101.

The internal bus 103 is a common bus for interconnecting the main memory 101 and HDD 102, thereby exchanging data.

Further, although not shown, an image display device for displaying a processing result or an input/output device such as a keyboard or the like for inputting processing data may be provided.

Next, an outline of a program for parallel execution according to this embodiment will be described below.

FIG. 2 is a view showing an example a processing flow of a conventional program for parallel execution. FIG. 2 shows a schematic diagram in which a plurality of programs, i.e., a first program 300 (program A), second program 301 (program B), and third program 302 (program C) are executed in parallel.

The programs are not executed independently of each other, and when a processing result of the other program is used for processing of a program, or for securing consistency of data, completion of processing of a specific part must wait in some cases. When programs having such a feature are executed in parallel, contrivances for acquiring execution states of the other programs must be embedded in various parts of the programs. By embedding the contrivance (also called synchronous processing), the configuration has been made in such a manner that data security or exclusive control is realized between the programs, and cooperative operations are obtained.

For example, when a predetermined event has occurred during the processing of program 300, program 301 is requested to take a predetermined processing (event 303). Upon receipt of event 303, program 301 executes a predetermined processing, and when a predetermined condition has been established, further issues an event 304 to program 302. Program 301 returns the result of the processing requested by program 300 to execute by means of event 303 to program 300 as an event 305.

However, when a description for synchronizing the parallel processes is included in the program itself, considerations not connected with the original program logic become necessary, making the program complicated. Also, while waiting for processing by other programs to complete, resources are wasted. In addition, there are many instances where subsequent program modification becomes difficult such as in a case where the processing efficiency varies greatly because of a slight deviation in timing.

In contrast, in this embodiment, a program is divided into basic modules (also called serial execution modules) and a parallel execution control description. The basic module is executable on condition that input data has been given irrespectively of the execution states of the other programs and is executed without serial and synchronous processing. The parallel execution control description describes relationships between parallel processing of a plurality of basic modules by using graph data structure creation information with the basic module being a node. By describing a part that requires synchronization or delivery of data by means of the parallel execution control description, it is made possible to promote conversion of the basic modules into components, and compactly manage the parallel execution control description.

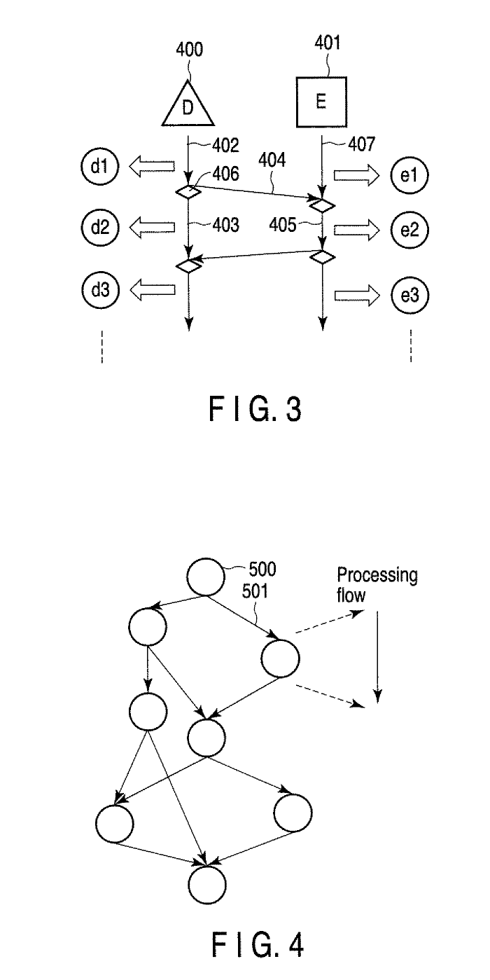

FIG. 3 is a view for explaining an example of a program division method according this embodiment. FIG. 3 shows a program 400 (program D) and a program 401 (program E) performing synchronous processing with respect to each other.

Program 400 executes thread 402, and program 401 executes thread 407. When thread 402 is executed up to a point 406, it is necessary for program 400 to deliver the processing result to program 401. Thus, upon completion of the execution of thread 402, program 400 notifies the processing result to program 401 as an event 404. Only after both event 404 and the processing result of thread 407 are obtained, program 401 can execute next thread 405. On the other hand, upon completion of the execution of thread 402, program 400 executes the program subsequent to the point 406 as thread 403.

As described above, in programs 400 and 401, there are parts in which processing can be unconditionally advanced such as threads 402 and 407, and a point at which a certain processing result to be notified to the other thread can be obtained while the program is executed such as the point 406, or a point at which the processing can be started on condition that a processing result from the other thread is obtained.

Thus, as shown in FIG. 3, the program is divided at a point such the point 406, and the processing units of the program after the division are defined as basic modules d1, d2, d3, . . . , and basic modules e1, e2, e3, . . . . In FIG. 3, although the two programs D and E related to each other are shown, even when more than two programs related to each other are present, the programs can be divided on the basis of the similar way of thinking. The basic modules d1, d2, d3, . . . , and the basic modules e1, e2, e3, . . . are serial execution modules that can be executed without synchronous processing.

FIG. 4 is a view showing a graph data structure for explaining an example of interdependence between basic modules according to this embodiment. The interdependence between modules implies a relationship in which a module #1 can be executed only after completion of a module #2, or the like. The circular mark in FIG. 4 constituting the basic module 500 indicates one of the basic modules d1, d2, . . . , and e1, e2, . . . shown in FIG. 3. To the basic module 500 to be first executed, a modularized program in which processing can be unconditionally advanced independently of the other thread is assigned. The basic module 500 is related to the other basic module on the basis of a link 501 indicating the interdependence with the other basic module.

The interdependence in FIG. 4 shows that each basic module receives an event such as a calculation result output from a preceding basic module connection of which with each basic module is defined by the link 501 and, at the same time, makes an event to happen to a succeeding basic module connection of which with each basic module is defined by the link.

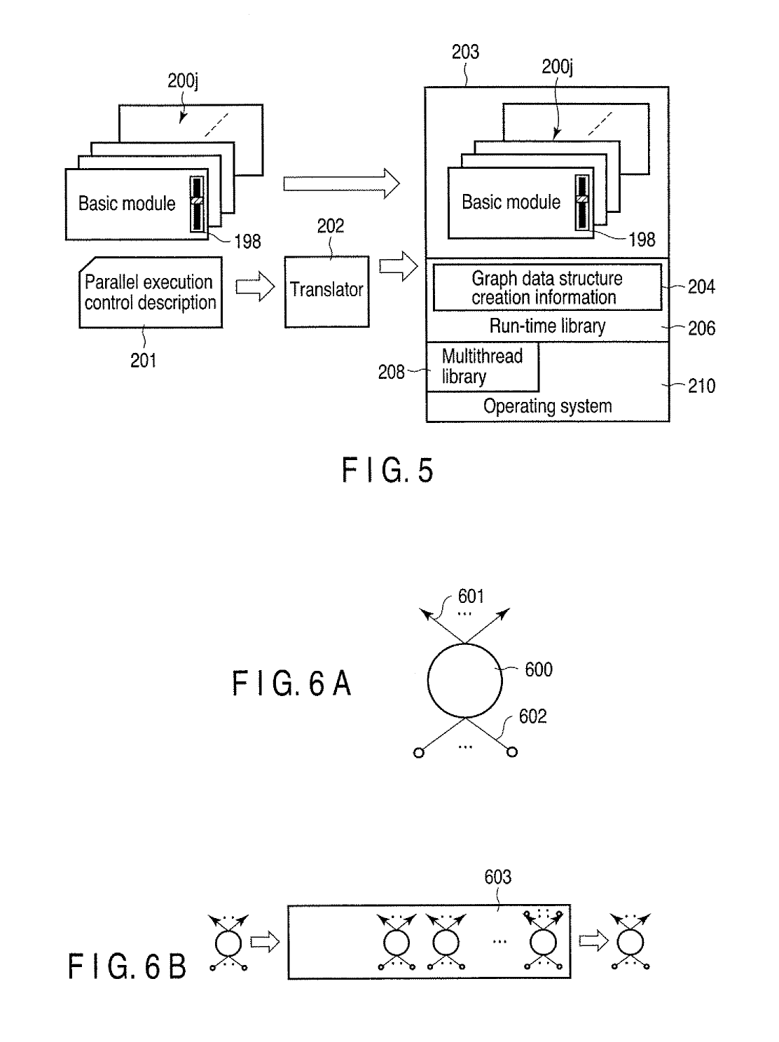

FIG. 5 is a view showing an example of translation of a program according to this embodiment.

Basic modules 200j (j=1, 2, . . . ) constitute a program to be executed by the system according to this embodiment. Each of the basic modules 200j can receive one or more parameters 198, and can adjust the execution load by changing, for example, algorithm to be applied or by changing a threshold or coefficient on the algorithm on the basis of a value or values of the parameter or parameters 198.

The parallel execution control description 201 includes data to be referred at the time of execution. The parallel execution control description 201 indicates interdependence (FIG. 4) of each of the basic modules 200j at the time of parallel processing, the relationship being converted into graph data structure creation information 204 by a translator 202 before being executed by the information processing apparatus 203. The translator 202 extracts a part relating to each of the plurality of basic modules from the parallel execution control description, and creates graph data structure creation information including part of the parallel execution control description, i.e., at least information on a basic module precedent to a basic module, and information on a basic module subsequent to the basic module. The graph data structure creation information 204 is stored in a run-time library 206.

As for the translator 202, in addition to the case where conversion is performed in advance before the execution of the basic module 200, a method is conceivable in which, during execution of the basic module, the processing is performed while translation is successively executed by a run-time task or the like.

The software on the information processing apparatus 203 at the point of execution is constituted of the basic modules 200j, the run-time library 206 (for storing the graph data structure creation information 204), a multithread library 208, and an operating system 210.

The run-time library 206 includes an application program interface (API) and the like used when the basic modules 200j are executed on the information processing apparatus 203, and is also provided with a function for realizing exclusive access control which is needed when the basic modules 200j undergo parallel execution. On the other hand, the configuration may be made in such a manner that the function of the translator 202 is called from the run-time library 206, and when the function is called in the process of executing the basic module 200, the parallel execution control description 201 of a part to be executed next time may be converted each time. By the configuration described above, a resident task for translation becomes unnecessary, and the parallel processing can be made more compact.

The operating system 210 manages the whole system such as the hardware of the information processing apparatus 203, and task scheduling. By introducing the operating system 210, the merits can be obtained that the programmer is liberated from management of the system of various kinds, can concentrate on programming, and can also develop software that can be run on a general type of apparatus.

In the information processing apparatus according to this embodiment, the program is divided at a part requiring synchronous processing or data delivery, and the matters associated with the division are defined as the parallel execution control description, whereby it is possible to promote the conversion of the basic module into components, and compactly manage the parallel processing definition. The execution load of each basic module converted into a component can be dynamically adjusted.

As shown in FIG. 5, the parallel execution control description 201 is temporarily converted into the graph data structure creation information 204, and the run-time processing for interpreting and executing the information 204 is executed in parallel, whereby it is possible to reduce the overhead, and secure the flexibility of the programming. This run-time processing is executed by threads of a number larger than at least the number of the processor cores, the dynamically created graph data structure is interpreted, a basic module 200j to be executed is selected, execution of the basic module 200j is repeated while the graph data structure is updated, whereby the parallel processing is realized.

FIGS. 6A and 6B are views for explaining an example of a data structure of a node 600 which is a basic constituent element of the graph data structure shown in FIG. 4. The node 600 corresponds to the basic module, and is obtained by forming the basic modules 200j into the graph data structure on the basis of information obtained after converting the parallel execution control description 201 of FIG. 5 into the graph data structure creation information 204 by means of the translator 202. The node 600 has interdependence with the other node through a link. The node 600 is automatically created by a parallel execution designation program of the basic module, and the number of links or connectors is a value determined for each type of module. This graph data structure is dynamically created by the run-time processing on the basis of the graph data structure creation information 204 expressing the relationship between the node to be added for each type of input data (or an output request) and the connection destination.

As shown in FIG. 6A, the node 600 includes a plurality of links 601 to basic modules that create data to be referred when the basic module is operated, and also includes a plurality of connectors 602 for connecting with basic modules which will refer to data created by these basic modules. The link 601 is a link to be connected to an output end of the other node needed to obtain data necessary for the node 600 to execute predetermined processing. Each of the links 601 includes definition information indicating a link to a required output end, or the like.

The connector 602 is provided with identification information indicating what is data output from the node 600 after processing. A succeeding node can determine whether or not conditions for enabling the node itself to be executed have been fulfilled on the basis of the identification information of the connector 602 and the parallel execution control description 201.

When the conditions for enabling the node 600 to be executed are regarded by the run-time library 206 as being fulfilled, IDs (or basic module IDs) of the nodes 600 are stored in an executable pool 603 in units of nodes as shown in FIG. 6B, an ID of a node to be executed next is selected and extracted from the nodes in the pool 603, and is executed. The executable pool 603 is a kind of register to which node IDs are input successively, and from which one of the node IDs is arbitrarily extracted.

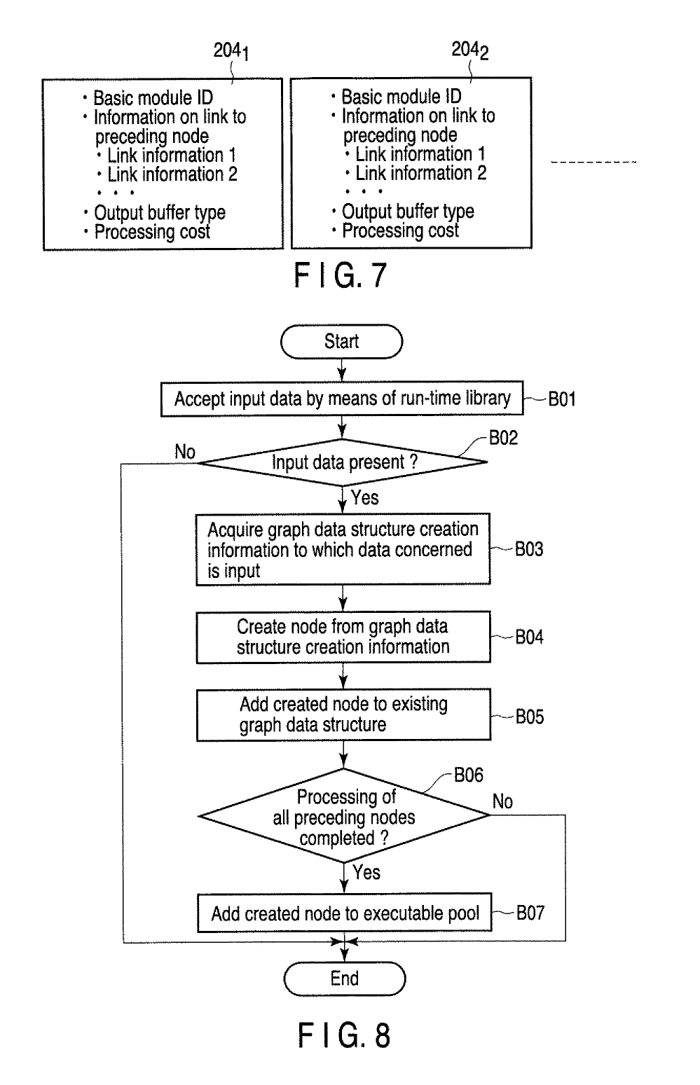

FIG. 7 is a view showing an example of graph data structure creation information 204 of a node according to this embodiment. In FIG. 7, graph data structure creation information items 204₁, 204₂, . . . translated from the parallel execution control description 201 for each basic module are shown. As information, a basic module ID, information on a plurality of links to preceding nodes, a type of an output buffer of the node concerned, and a processing cost of the node concerned are included. The cost information indicates a cost associated with the processing of the basic module 200 corresponding to the node concerned. This information is taken into consideration when a node to be extracted next is selected from nodes stored in the executable pool 603.

In the information on the links to the preceding nodes, a condition of a node to be a node precedent to the node concerned is defined. For example, definitions of a node outputting data of a predetermined type, a node including a specific ID, and the like are conceivable.

The graph data structure creation information 204 is used as information for expressing the corresponding basic module 200 as a node, and information for adding the basic module to the existing graph data structure shown in FIG. 4 on the basis of the link information or the like.

FIG. 8 is a view showing an example of an adding processing flow of graph data structure according to this embodiment. The processing of FIG. 8 is executed by one of the processors 100ᵢ.

When the flow has been executed, if the execution of the preceding node has been completed, a node executable at the time is created on the basis of the graph data structure creation information 204, and is stored in the executable pool 603.

The run-time library 206 managing the multithreading accepts input data which becomes the object to be executed (block B01).

The run-time library 206 sets the operating environment in such a manner that the library 206 is called from each core to execute multithreading. This makes it possible to perceive the parallel program as a model in which each core operates independently from a model in which the run-time processing operates independently, and keep the amount of synchronism waiting in the parallel processing at a small value by making the overhead of the run-time processing small. If the operating environment is configured in such a manner that the basic module is called by a single run-time task, switching between a task executing the basic module and the run-time task is executed complicatedly, and hence the overhead increases.

The run-time library 206 determines whether or not input data is present (block B02). When input data is not present (No), the series of the processing flow is terminated.

When input data is present (Yes) in block B02, graph data structure creation information 204 to which the input data is input is extracted, thereby acquiring the information 204 (block B03).

Output data of the basic module 200 is classified in advance into a plurality of types to be described in the output buffer types of the graph data structure creation information 204. In extracting the graph data structure creation information 204 to which the input data is input, it is sufficient if information in which a data type coincides with that of preceding input data is extracted on the basis of a data type to be the input data included in the information on the link to the preceding node described in the graph data structure creation information 204.

Then, a node corresponding to the graph data structure creation information 204 acquired in block B03 is created (block B04).

Here, when a plurality of graph data structure creation information items 204 are extracted, a node corresponding to each of the information items 204 is created.

The created node is then added to the existing graph data structure (block B05). The existing graph data structure mentioned here is a structure obtained by structuralizing interdependence precedent to and subsequent to a created node as shown in, for example, FIG. 4 on the basis of the information on the link to a preceding node of a node created from the graph data structure creation information 204, and the output buffer type.

Then, it is determined whether or not the processing of all the nodes corresponding to the preceding nodes of the added node has been completed (block B06).

When the processing is completed (Yes) with respect to all the preceding nodes of a certain node, the conditions for starting to execute the node 600 are regarded as being fulfilled, and the node is stored in the executable pool 603 (block B07).

On the other hand, when there is a preceding node for which the processing is not completed yet (No), the processing of the node itself cannot be started, and the flow is terminated.

As described above, even when a node is created, the basic module corresponding to the node is not immediately executed, and the processing is reserved until interdependence with the other node of the added graph data structure is satisfied.

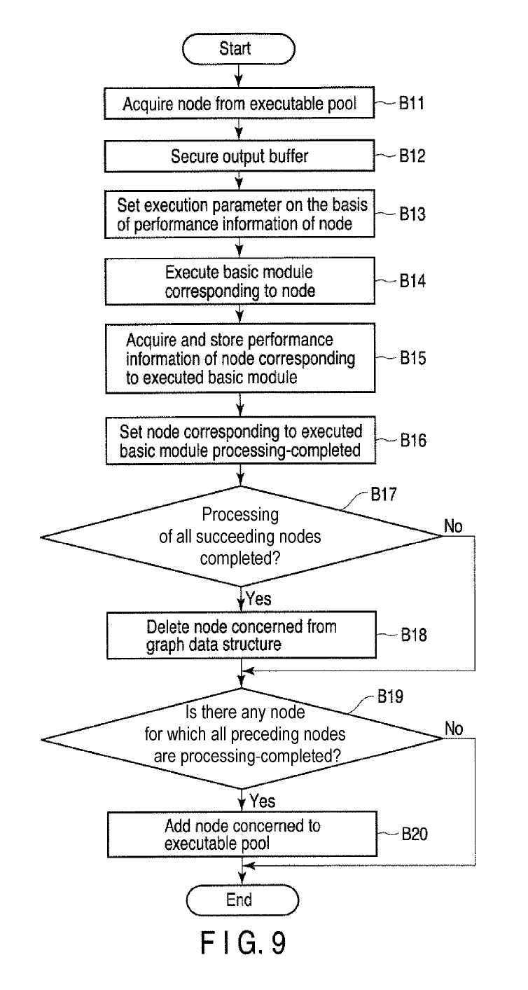

FIG. 9 is a view showing an example of basic module processing according to this embodiment. In this flow, an example in which a node stored in the executable pool 603 is selectively read, and a corresponding basic module is executed is shown. The processing of FIG. 9 is also executed by one of the processors 100ᵢ.

A node to be executed next is selected from nodes which are stored in the executable pool 603, and have already become executable on the basis of a predetermined condition (block B11).

The predetermined condition can be selected on the basis of a point of reference such as the oldest stored node, a node having many succeeding nodes, a node with high cost, and the like.

The cost of each node may be obtained by the following calculation.

Cost of an added node =(α×past average execution time) +(β×amount of usage of output buffer) +(γ×number of succeeding nodes) +(δ×execution frequency at nonscheduled time)

In general, it is conceivable that starting processing from the node of higher cost makes the throughput of the parallel processing larger. Here, the execution frequency at the nonscheduled time implies a frequency at which a state where none of the nodes is stored in the executable pool 603 during the execution of the basic module appears. This state means that an underflow of the executable pool 603 has occurred, which degrades the degree of the parallel processing, and hence is undesirable. The cost of the basic module 200 in execution at this time is calculated higher, and hence the basic module is executed earlier, whereby it is possible to expect an effect on the avoidance of a bottleneck.

As each of the coefficients α to δ of the linear expressions of the cost calculating formula, a predetermined value may be used, or the coefficients may also be configured to dynamically change while observing the state of the processing.

An example of acquisition of a node will be described later.

When a node to be executed next is acquired, an output buffer in which the processing result of the node is to be stored is secured before the execution (block B12).

The output buffer is secured on the basis of the definition of the output buffer type defined by the graph data structure creation information 204.

When the output buffer can be secured, one or more parameter values that can be received by the basic module are set on the basis of the performance information obtained and preserved at the time of the last execution of the basic module corresponding to this node (block B13), and execution of the basic module 200 corresponding to this node is started (block B14).

Further, when the processing of the basic module 200 is completed, the performance information is acquired and preserved (block B15), and an execution completion flag of the node concerned in the graph data structure is set processing-completed (block B16).

In block B15, a set of the parameter of the basic module 200 for which the processing has been completed, and the execution time is recorded as performance information.

Then, it is determined whether or not all the succeeding nodes included in the graph data structure of the node concerned are processing-completed (block B17). When all the succeeding nodes are processing-completed (Yes), the node can be deleted from the graph data structure (block B18). At this time, the output data of the node is not used, and hence the output buffer secured in block B12 is released. Conversely, when there is any node which is still processing-uncompleted in the succeeding nodes, there is the possibility of the output data of the node being used by the basic module of the succeeding node, and hence the node must not be deleted from the graph data structure.

Then, it is determined, with respect to each of all the nodes included in the graph data structure, whether or not all the preceding nodes of the node are processing-completed (block B19). When there is a node preceding nodes of which are all processing-completed (Yes), the node is regarded as having fulfilled the execution start conditions, and is stored in the executable pool 603 (block B20).

When even only one of the preceding nodes is processing-uncompleted (No), the determination is performed again when the processing of the preceding node is completed.

As described above, when the run-time processing accepts an input, a list of a “set of a node and a connection destination” (FIG. 7) which is graph data structure creation information 204 corresponding to a type of input data is obtained, and nodes are added in sequence to the existing graph data structure (FIG. 4) in accordance with the list. When the addition of nodes to the graph data structure is completed, if all the preceding nodes of the node are execution-completed, the added nodes are added to the executable pool 603. In the execution of the basic module by the run-time processing, each of the threads executing in the processor cores independently selects an execution module, and updates the graph data structure to perform processing, whereby the parallel processing is realized.

In the basic module selection processing, and update processing of the graph data structure, exclusive control becomes necessary. However, this is performed by the run-time processing, and hence the parallel program designer is not conscious of the exclusive control.

The basic module does not include the synchronous processing, and hence is serially executed to the last and, when the execution is completed, the flow returns to the run-time processing.

Next, a method of selecting a basic module to be executed in block B11 will be described below.

In this embodiment, the parallel processing is constituted of a basic module to be executed serially, and run-time processing for assigning basic modules to a plurality of processors in regular order. Reduction in processing time of run-time processing is desired, and the processing time depends on the occurrence of a cache error. Accordingly, by observing the occurrence state of the cache error, and appropriately determining, on the basis of the observation result, to which processor a node to be executed next is to be assigned, it is possible to shorten the run-time processing time.

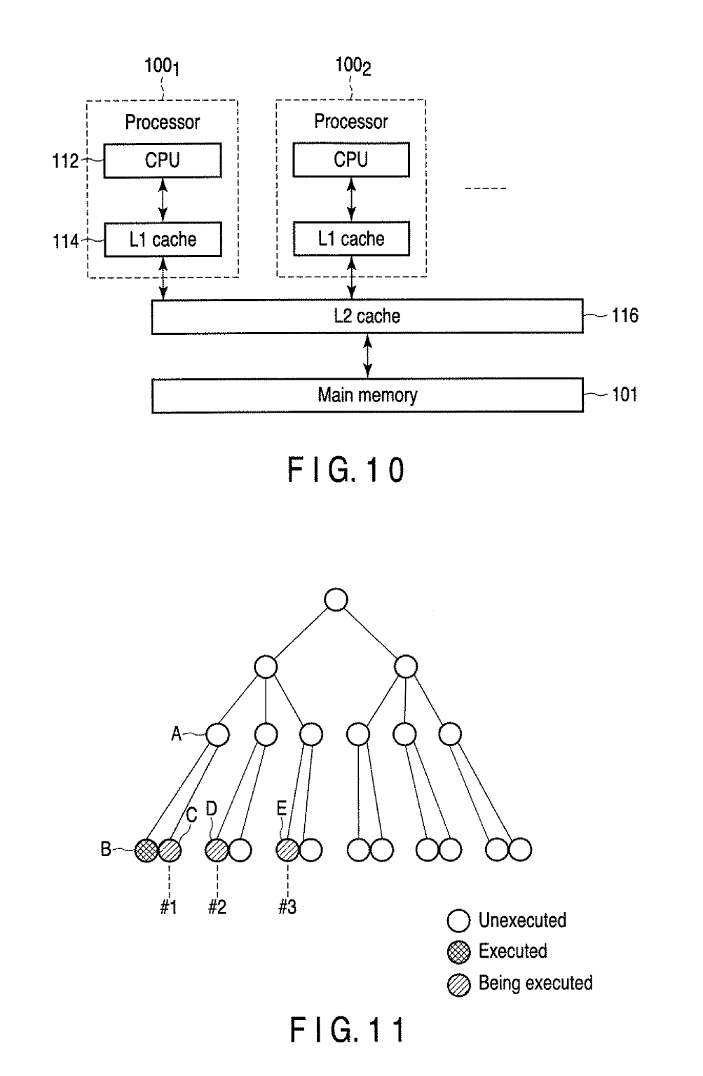

Although this embodiment does not limit the memory hierarchy of the system, it is assumed for convenience' sake of explanation that the system includes a cache memory hierarchy of three stages as shown in FIG. 10. An L1 cache 114 is provided in each processor 100, and is connected to a CPU 112. Between the processor 100 and the main memory 101, an L2 cache 116 is connected. The L1 cache 114 and L2 cache 116 each include a synchronization mechanism constituted of hardware, and perform synchronous processing required when the same address is accessed. The L2 cache 116 retains data of an address referred to by the L1 cache 114, and when a cache error occurs, necessary synchronous processing is performed between the L2 cache 116 and the main memory 101 by means of the synchronization mechanism constituted of hardware.

FIG. 11 shows a state of a range of nodes at the time of execution of certain parallel processing. Here, although the description is given by a tree structure for simplicity, the description may be given by the graph data structure as shown in FIG. 4. In FIG. 11, the vertical direction indicates the interdependence, and when nodes B and C are linked in the downward direction of a node A, it is indicated that node A depends on nodes B and C. Processing of node A cannot be started unless the processing of nodes B and C is completed. Regarding the description of the relationships, node A is called a parent of nodes B and C, nodes B and C are called children of node A, and nodes B and C are each called brothers. A numeral (preceded by #) indicates the number of a CPU that executes a basic module corresponding to the node. An unexecuted node is indicated by a void circle, an executed node is indicated by a circle with oblique lines in both directions, and a node being executed is indicated by a circle with oblique lines in one direction. Here, it is indicated that three nodes C, D, and E undergo parallel processing by CPUs #1, #2, and #3.

When a certain CPU has completed processing of a certain node, there are two methods of searching for a node to be executed next, i.e., first search and second search.

In the second search, a search is made from a node up to a node of the highest level, and then a search is made from that node down to an unexecuted closest node of the lowest level. On the other hand, in the first search, a search is made from a node toward the higher level in the tree structure. It is determined at each node whether or not a child node is unexecuted, and when an unexecuted child node is present, the search is turned back at the child node, thereby reaching an unexecuted child node.

In the structure in which interdependence is as shown in FIG. 11, it is common that between nodes having close interdependence (for example, nodes B and C), data areas to be referred to overlap each other. When data areas to be referred to overlap each other for two nodes to be subjected to parallel processing, synchronous processing between the L1 cache memory 114 and the CPU 112 is performed frequently, and the processing efficiency is lowered. On the other hand, when two nodes of addresses distantly separate from each other in order that the data areas to be referred to may not overlap each other undergo parallel processing, access to a data area that cannot be contained in the L2 cache 116 occurs, and synchronous processing between the L2 cache 116 and the main memory 101 is frequently performed, whereby the processing efficiency is also lowered.

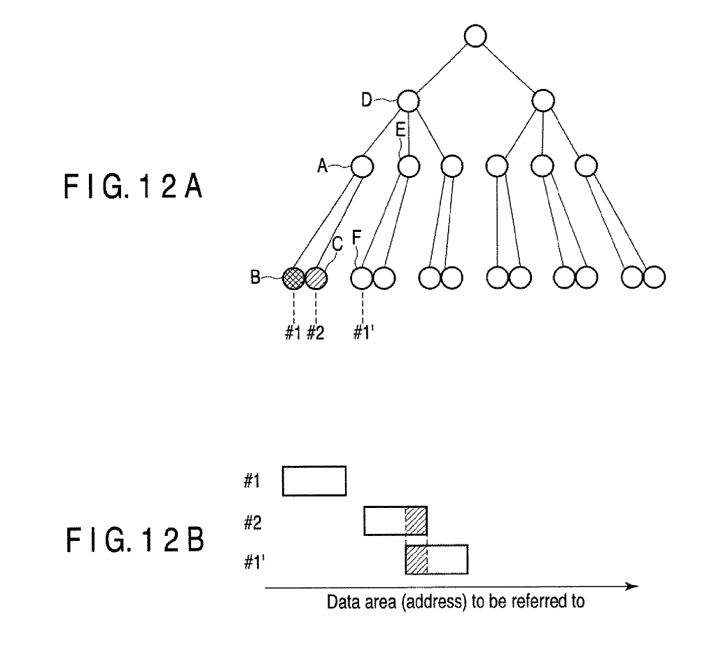

In order to specifically explain the synchronous processing of the cache, it is assumed that first search is performed in the graph data structure indicating the interdependence as shown in FIG. 12A. In the state where node B is execution-completed, and node C is being executed, when first search is performed, and the search is advanced from node B to nodes A and D, there is an unexecuted node which is a child node of node D, and hence the search is turned back at node D. Thereafter, the search is advanced from node D through node E, and finally node F is chosen as the node to be executed next.

Assuming that nodes B and C have already been assigned to CPUs #1 and #2, respectively, the next node F is assigned to CPU #1 that has completed the processing of node B. However, in nodes C and F which have close interdependence, it is common that the data areas to be referred to overlap each other, and hence the data areas required by CPUs #1 and #2 overlap each other as shown in FIG. 12B. Accordingly, synchronous processing between the L1 cache 114 and the CPU 112 is frequently performed, and the processing efficiency is lowered.

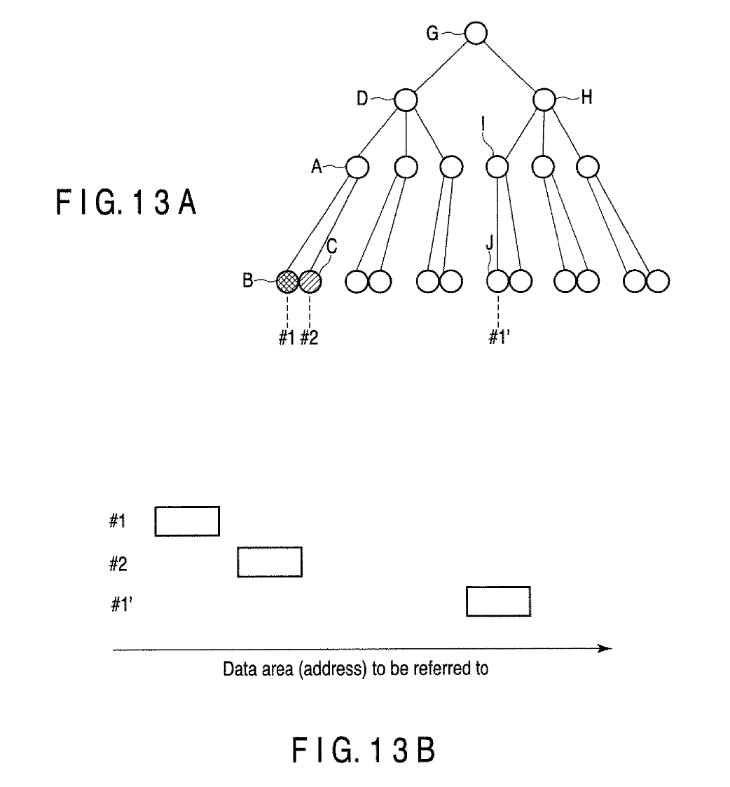

It is assumed that second search is performed in the graph data structure indicating the interdependence as shown in FIG. 13A. In the state where node B is execution-completed, and node C is being executed, when second search is performed, the search is advanced from node B up to node G of the highest level through nodes A and D, and is turned back at node G. After this, the search is advanced from node G through nodes H and I and, finally node J is chosen as the node to be executed next. It should be noted that although illustration is omitted, a plurality of levels (nodes) are present between nodes D and H; and node G.

Assuming that nodes B and C have already been assigned to CPUs #1 and #2, respectively, the next node J is assigned to CPU #1 that has completed the processing of node B. There is hardly any interdependence between nodes C and J, and hence there is the possibility of the data areas required by CPUs #1 and #2 being unable to be contained in the L2 cache. In this case, the synchronous processing between the L2 cache and the main memory is frequently performed, and the processing efficiency is lowered.

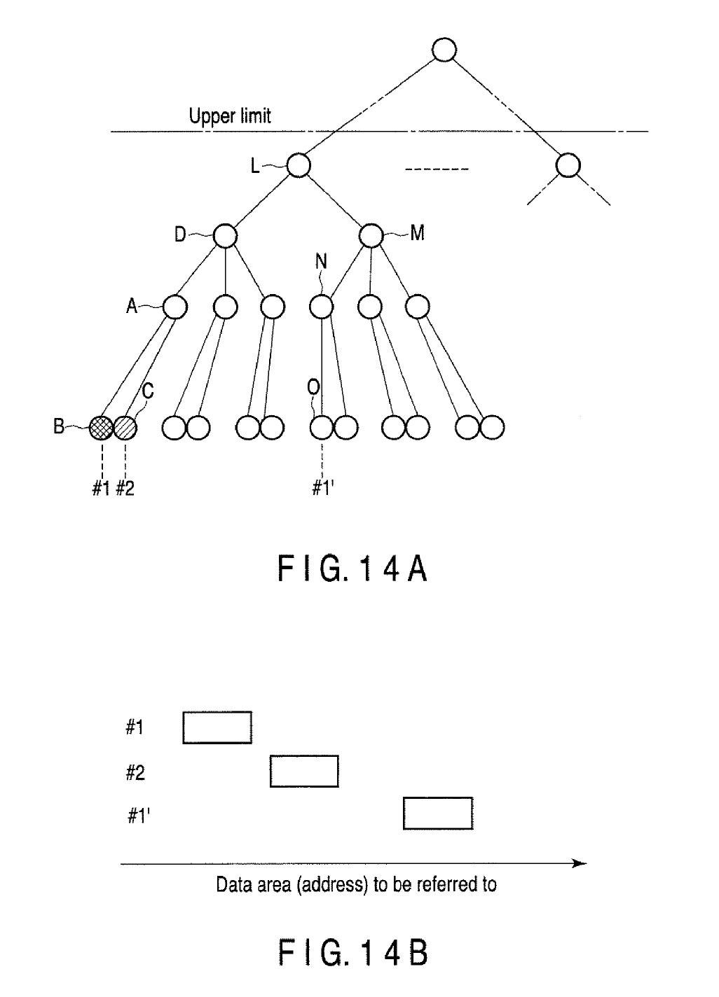

Thus, in this embodiment, as shown in FIG. 14A, the return position is restricted in the second search so that the breadth is restricted, whereby the data areas to be referred to in the parallel processing are securely contained in the L2 cache, and the address areas are separated from each other as distantly as possible in order that the address areas may not overlap each other as shown in FIG. 14B (in order that synchronous processing between the L1 cache and the CPU may not occur).

If the occurrence frequency of the synchronous processing between the L2 cache and the main memory can be detected, determination of the upper limit of the return position in the second search can be made on the basis of the detection result. However, at present, it is difficult to detect the occurrence frequency of the synchronous processing. Thus, by profiling the processing performance while adaptively changing the upper limit of the return position, it is possible to substantially detect the occurrence frequency of the synchronous processing.

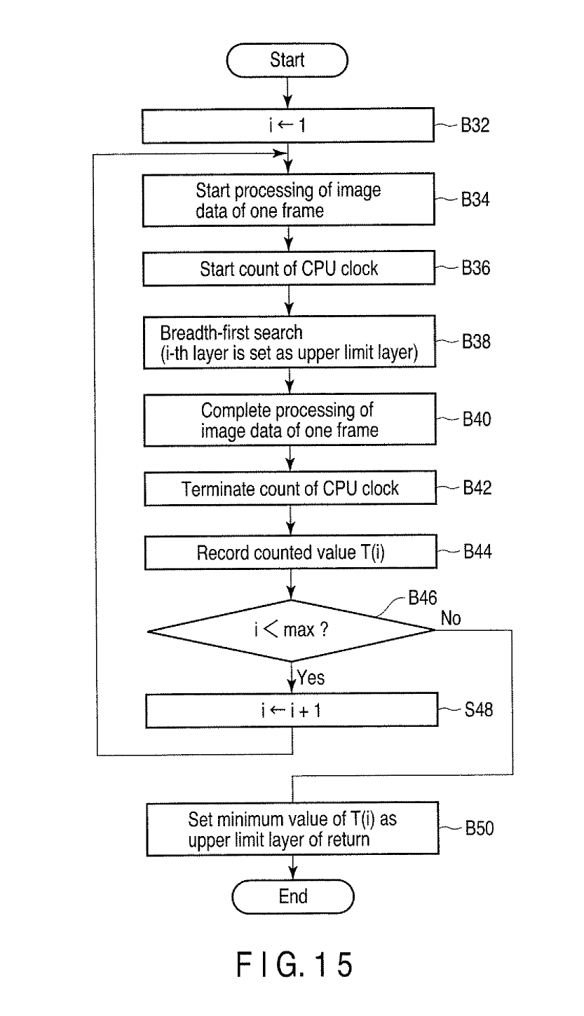

FIG. 15 shows a flowchart of an example of the processing for determining the level of an ordinal number counted from the lowest level as the upper limit. In block B32, 1 is set in the variable i. The variable i is a variable indicating the upper limit layer obtained when the lowest layer is set as the 0th layer. The processing of FIG. 15 is also executed by any one of the processors 100ᵢ.

In block B34, processing of the processing unit is started. The processing unit is, for example, when the data of the object to be processed is image data, image data of one frame. In block B36, the CPU clock is started. In block B38, a node to be executed next is determined by the second search in which an upper limit is set for the return position as shown in FIG. 14 (ith layer is set as the upper limit). The node determined in this way is assigned to a free CPU, whereby the parallel processing is performed and one frame of the image data is processed.

When the processing of the one frame of the image data is completed in block B40, the CPU clock is stopped in block B42. The counted value T(i) is recorded in block B44. It is determined in block B46 whether or not variable i has reached the maximum value. If variable i has not reached the maximum value, variable i is incremented in block B48, and the flow returns to block B34. When the variable has reached the maximum value, the minimum value of the counted value T(i) is detected in block B50, and the value i is made the upper limit layer. This is because the fact that the processing time obtained when the upper limit is changed to perform the actual processing is the shortest makes it possible to determine that the frequency of the synchronous processing performed between the L2 cache and the main memory is the minimum. At this time, it is possible to determine that the frequency of the synchronous processing performed between the L1 cache and the CPU is also the minimum.

As described above, according to this embodiment, when execution of a certain basic module has been completed in the parallel processing, and when a node to be executed next is searched for in order to determine which basic module should be executed next, it is possible to prevent the processing efficiency from being lowered by the synchronous processing performed between the L1 cache and the L2 cache while suppressing occurrence of a cache error of the L2 cache by performing second search in which the breadth is restricted by restricting the return position. Therefore, the processing time can be minimized on the basis of the correlation between the processing and the data area to be accessed. This makes it possible to enhance the performance of the whole processing.

Although the above description has been given of the search for a node based on the second search, a situation where the first search can be carried out without any problem also exists. When all the processing has been completed with respect to a certain node and nodes on which the node depends, it is possible to prevent the processing efficiency from being lowered by the synchronous processing performed between the L1 cache and the L2 cache by selecting a node to be executed next by the first search.

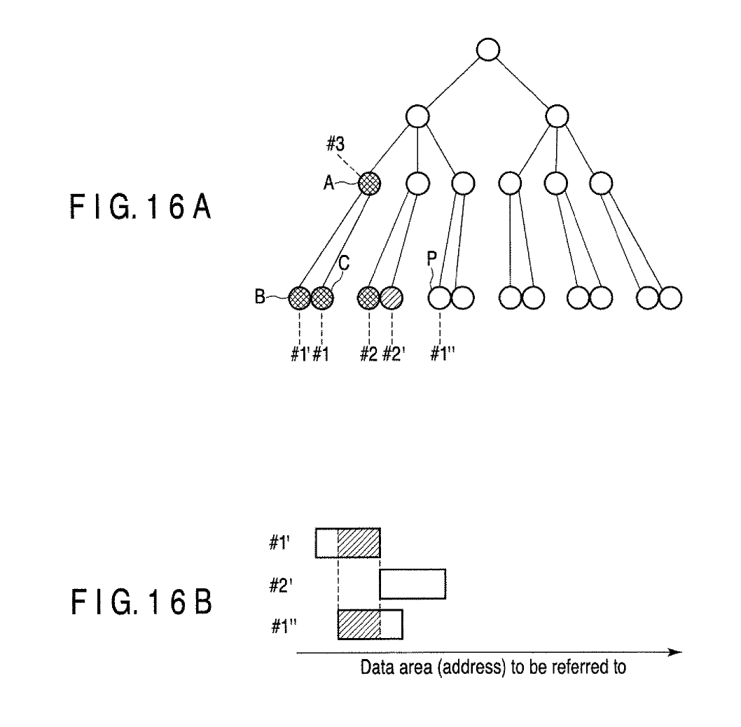

A data area to which a brother node refers is close to a data area to which the original node has referred in many cases. However, as shown in, for example, FIG. 16A, immediately after all the processing of nodes B, A, and C, the node A depending on nodes B and C, has been completed, the processing of the original node B has been completed as shown in FIG. 16B, and hence the access to the data area which has been accessed by CPU #1 that has executed node B has been completed. Thus, it is not necessary to perform the synchronous processing of the L1 cache even when the processing of node P determined by the first search is assigned to CPU #1. Furthermore, data accessed by node B is present on the L1 cache of CPU #1, and hence the possibility of the data accessed by node P close to node B being present is high. Accordingly, when the first search is performed, the probability of occurrence of the synchronous processing due to the reference to the same address by the L1 cache and L2 cache is reduced, and the performance of the whole parallel processing can be enhanced.

Although the above-mentioned search method is based on one of the second search and the first search, the optimum method may be determined by trial and error by combining both of them. More specifically, the processing load (for example, the processing time shown in FIG. 15) of the program module at the time when a plurality of search patterns constituted of a combination of the first search and the second search having various restricted breadths are carried out may be measured, and the search pattern which minimizes the processing load may be selected. When the data to be processed is an image stream, the shape of the graph data structure or the advance of the processing changes on the basis of the image characteristic. Alternately, the processor core in the system available at a certain point in time is variable. Therefore, the best result cannot be acquired by the specific search method in some cases. However, a combination in which search for the next node is not carried out by trial and error with respect to all the nodes, the method shown in FIGS. 14A, 14B, and 15 is used for the nodes of the normal type, and the method of selecting one of the search patterns is used for the nodes of the specific type, is also possible.

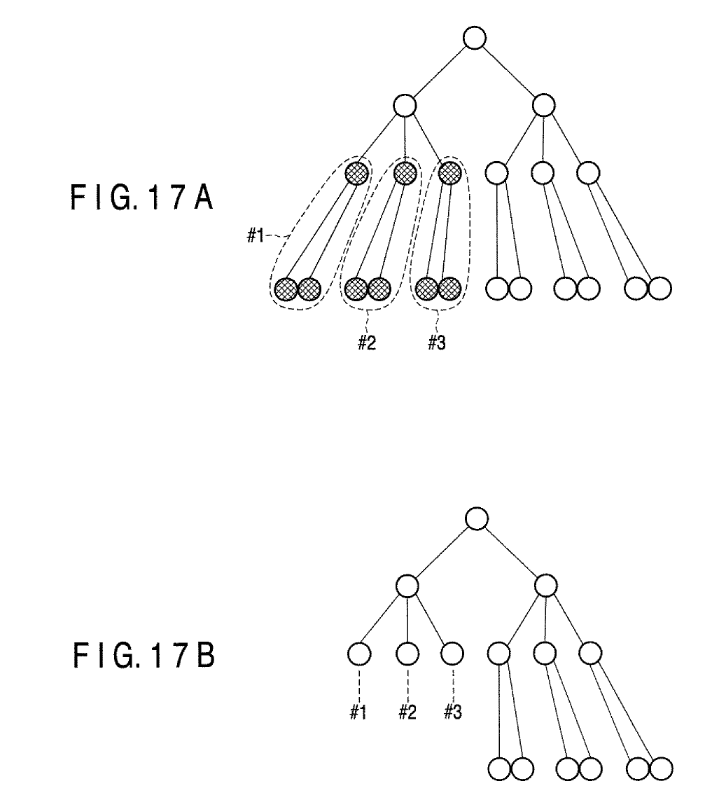

Next, although not a node search method, a method of improving the overall performance by updating the graph data structure will be described below. As shown in FIG. 17A, when it is known that an overall aggregation of nodes in which children can be recursively traced by using a certain node as a parent is to be assigned to a single CPU, the node group constituting the aggregation is regarded as a node, whereby the graph data structure is updated. As a result, with respect to nodes that can be regarded as nodes of which assignment to processors is fixed, determination processing for processor assignment becomes unnecessary, and hence the overall processing time of the parallel processing is reduced.

As described above, according to this embodiment, the parallel processing can be divided into a serial execution part (basic module) including neither synchronous processing nor exclusive processing, and a parallel designation part for describing the parallel operations, and hence it is possible to improve the descriptiveness of the parallel program, easily perform the program change at the time of performance tuning, and reduce the maintenance cost. Further, by means of the run-time processing for efficiently operating the parallel program prepared in this way, it is possible to obtain parallel execution performance scalable for the number of processors. The run-time task independently selects the executable basic module 200, and successively updates the graph data structure, whereby the parallel processing is performed. Accordingly, the series of processing need not be considered by an application program. Further, the basic module 200 does not include a part from which the other task branches off, and hence it is not necessary to consider any arbitration between itself and the other task being executed. Moreover, in accordance with the situation at each time, a contrivance capable of dynamically adjusting the execution load of each program is also realized.

Accordingly, it is possible to provide a programming environment which allows programs to be created without taking parallel processing into account, and which enables flexible execution of parallel processing by multithreading.

As has been described above, according to the present invention, it is not necessary to hard-code interdependence between threads, and hence the invention is excellent in the flexibility of program change, and the description of the synchronous processing between the threads is facilitated. Further, an effect of facilitating acquisition of scalability of the number of processors is also obtained.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The various modules of the systems described herein can be implemented as software applications, hardware and/or software modules, or components on one or more computers, such as servers. While the various modules are illustrated separately, they may share some or all of the same underlying logic or code. The accompanying claims and their equivalents are intended to cover such forms or modifications as would fall within the scope and spirit of the inventions.

What is claimed is:

1. An information processing apparatus comprising:
a storage configured to store program modules executable on condition that input data has been given irrespectively of execution states of other programs, and a parallel execution control description for describing relationships of the program modules at a time of parallel processing;
a conversion module configured to extract a part relating to each of the program modules from the parallel execution control description stored in the storage, and to create graph data structure creation information including at least preceding information and succeeding information for each of the program modules;
an adding module configured to extract graph data structure creation information to which the input data is given, to create a node based on the extracted graph data structure creation information, the created node comprising an executable node of which all preceding nodes in the graph data structure are execution-completed and a non-executable node, and to add the created node to a formerly created graph data structure based on the preceding information and the succeeding information;
a storing module configured to store the created node into a node memory when all nodes precedent to the created node in the graph data structure are execution-completed; and
an execution module configured to
execute one of a first search and a second search to determine a node to be executed next;
the first search for a node being made in the graph data structure from an executed node to a node having a non-executed child node through an upper layer node, the first search being turned back at the node having the non-executed child node, and the first search being made to the non-executed child node through a lower layer node, the non-executed child node being determined as the node to be executed next, and
the second search for a node being made in the graph data structure to a predetermined upper limit layer node through an upper layer node, the second search being turned back at the predetermined upper limit layer node, and the second search being made to a non-executed node through a lower layer node, the non-executed node being determined as the node to be executed next;
select the determined node to be executed next from nodes stored in the node memory; and
execute a program module corresponding to the selected node,
wherein the execution module is configured to measure a processing time of a program module for determining the node to be executed next in the second search while changing the predetermined upper limit layer and to determine a layer with a minimum processing time as the predetermined upper limit layer.

2. The apparatus of claim 1, wherein the execution module is configured to execute the first search when certain nodes including preceding nodes are all execution-completed.

3. The apparatus of claim 1, wherein the execution module is configured to measure a processing load of a program module when search patterns constituted of a combination of the first search and the second search with changing the predetermined upper limit layer are executed, and to execute one of the search patterns which minimizes the processing load.

4. The apparatus of claim 1, further comprising an updating module configured to detect a manner how a node group is assigned to a real processor in the graph data structure, and to update the graph data structure by regarding the node group as one node if there is a node group to be assigned to the same processor.

5. A program execution method executed by an information processing apparatus and using program modules executable on condition that input data has been given irrespectively of execution states of other programs and a parallel execution control description for describing relationships of the program modules at a time of parallel processing, the method comprising:
a conversion step executed by the information processing apparatus, extracting a part relating to each of the program modules from the parallel execution control description stored in a storage, and creating graph data structure creation information including at least preceding information and succeeding information of the program module for each of the program modules;
an adding step executed by the information processing apparatus, extracting graph data structure creation information to which the input data is given, creating a node based on the extracted graph data structure creation information, the created node comprising an executable node of which all preceding nodes in the graph data structure are execution-completed and a non-executable node, and adding the created node to a formerly created graph data structure based on the preceding information and the succeeding information;
a storing step executed by the information processing apparatus, storing the created node into a node memory when all nodes precedent to the created node in the graph data structure are execution-completed; and
an execution step executed by the information processing apparatus, executing one of a first search and a second search to determine a node to be executed next;
the first search for a node being made in the graph data structure from an executed node to a node having a non-executed child node through an upper layer node, the first search being turned back at the node having the non-executed child node, and the first search being made to the non-executed child node through a lower layer node, the non-executed child node being determined as the node to be executed next;
the second search for a node being made in the graph data structure to a predetermined upper limit layer node through an upper layer node, the second search being turned back at the predetermined upper limit layer node, and the second search being made to a non-executed node through a lower layer node, the non-executed node being determined as the node to be executed next; and
executing a program module corresponding to the node to be executed next.

6. The method of claim 5, wherein the execution step comprises executing the first search when certain nodes including preceding nodes are all execution-completed.

7. The method of claim 5, wherein the execution step comprises measuring a processing load of a program module when search patterns constituted of a combination of the first search and the second search with changing the predetermined upper limit layer are executed, and executing one of the search patterns which minimizes the processing load.

8. The method of claim 5, further comprising an updating step of detecting a manner how a node group is assigned to a real processor in the graph data structure, and updating the graph data structure by regarding the node group as one node if there is a node group to be assigned to the same processor.

9. A non-transitory computer readable medium storing a computer program making processors perform a parallel processing, the computer program controlling a computer to perform steps of:
storing program modules executable on condition that input data has been given irrespectively of execution states of other programs, and a parallel execution control description for describing relationships of the program modules at a time of parallel processing;
extracting a part relating to each of the program modules from the parallel execution control description stored in the storage, and to create graph data structure creation information including at least preceding information and succeeding information for each of the program modules;
extracting graph data structure creation information to which the input data is given, to create a node based on the extracted graph data structure creation information, the created node comprising an executable node of which all preceding nodes in the graph data structure are execution-completed and a non-executable node, and to add the created node to a formerly created graph data structure based on the preceding information and the succeeding information;
storing the created node into a node memory when all nodes precedent to the created node in the graph data structure are execution-completed; and
executing one of a first search and a second search to determine a node to be executed next;
the first search for a node being made in the graph data structure from an executed node to a node having a non-executed child node through an upper layer node, the first search being turned back at the node having the non-executed child node, and the first search being made to the non-executed child node through a lower layer node, the non-executed child node being determined as the node to be executed next;
the second search for a node being made in the graph data structure to a predetermined upper limit layer node through an upper layer node, the second search being turned back at the predetermined upper limit layer node, and the second search being made to a non-executed node through a lower layer node, the non-executed node being determined as the node to be executed next;
executing a program module corresponding to the node to be executed next.

10. The non-transitory computer readable medium of claim 9, wherein the computer program controlling the computer performs further step of executing the first search when certain nodes including preceding nodes are all execution-completed.

11. The non-transitory computer readable medium of claim 9, wherein the computer program controlling the computer performs further steps of measuring a processing load of a program module when search patterns constituted of a combination of the first search and the second search with changing the predetermined upper limit layer are executed, and executing one of the search patterns which minimizes the processing load.

12. The non-transitory computer readable medium claim 9, wherein the computer program controlling the computer performs further steps of:
detecting a manner how a node group is assigned to a real processor in the graph data structure, and updating the graph data structure by regarding the node group as one node if there is a node group to be assigned to the same processor.
